(19) United States
(12) Patent Application Publication
(10) Pub. No.: US 2018/0253044 A1
(43) Pub. Date: Sep. 6, 2018

(54) IMAGE FORMING APPARATUS

(71) Applicant: KYOCERA Document Solutions Inc., Osaka (JP)

(72) Inventors: Akira HORIE, Osaka-shi (JP); Masaaki MARUTA, Osaka-shi (JP)

(73) Assignee: KYOCERA Document Solutions Inc., Osaka (JP)

(21) Appl. No.: 15/907,798

(22) Filed: Feb. 28, 2018

(30) Foreign Application Priority Data
Mar. 3, 2017 (JP) 2017-040192

(51) Int. Cl. G03G 15/20

(52) U.S. Cl. CPC G03G 15/2064

(57) ABSTRACT

An image forming apparatus includes an image forming section, a fixing section, and a frame unit. The image forming section forms a toner image on a sheet. The fixing section fixes the toner image to the sheet. The frame unit supports the image forming section and the fixing section. The fixing section includes a fixing unit and a nip pressure changing section. The fixing unit forms a fixing nip that applies heat and pressure to the sheet. The nip pressure changing section changes nip pressure of the fixing nip. The fixing unit includes an abutment portion. The frame unit includes a unit fitting compartment into which the fixing unit is to be fitted and a receiving portion that receives the abutment portion once the fixing unit is fitted into the unit fitting compartment.

### INCORPORATION BY REFERENCE

The present application claims priority under 35 U.S.C. § 119 to Japanese Patent Application No. 2017-040192, filed on Mar. 3, 2017. The contents of this application are incorporated herein by reference in their entirety.

### BACKGROUND

The present disclosure relates to an image forming apparatus.

Some image forming apparatus includes a frame unit and a fixing section. The fixing section fixes a toner image to paper. Specifically, the fixing section includes a fixing unit and a nip pressure changing section. The fixing unit includes a heating roller, a pressure roller, and a fixing unit frame. The fixing unit frame supports the heating roller and the pressure roller. The heating roller forms a fixing nip in cooperation with the pressure roller. Heat and pressure are applied to the paper when the paper passes through the fixing nip. The nip pressure changing section changes nip pressure of the fixing nip through urge on the pressure roller.

The frame unit supports the fixing section. Specifically, the frame unit includes a center frame and right and left side frames. The right and left side frames extend in an up-down direction. The center frame extends across in a horizontal direction between the right and left side frames. A unit fitting compartment is defined below the center frame between the right and left side frames. The fixing unit is fitted into the unit fitting compartment. After being fitted into the unit fitting compartment, the fixing unit frame is secured to the center frame for example by means of a securing member such as a screw.

### SUMMARY

An image forming apparatus according to the present disclosure includes an image forming section, a fixing section, and a frame unit. The image forming section forms a toner image on a recording medium. The fixing section fixes the toner image to the recording medium. The frame unit supports the image forming section and the fixing section. The fixing section includes a fixing unit and a nip pressure changing section. The fixing unit forms a fixing nip that applies heat and pressure to the recording medium. The nip pressure chancing section changes nip pressure of the fixing nip. The fixing unit includes an abutment portion. The frame unit includes a unit fitting compartment and a receiving portion. The fixing unit is to be fitted into the unit fitting portion. The receiving portion receives the abutment portion once the fixing unit is fitted into the unit fitting compartment.

### BRIEF DESCRIPTION OF THE DRAWINGS

FIG. 1 is a perspective view illustrating an image forming apparatus according to an embodiment of the present disclosure.

FIG. 2 is a diagram illustrating a configuration of the image forming apparatus according to the embodiment of the present disclosure.

FIG. 3 is a diagram illustrating a configuration of a fixing section according to the embodiment of the present disclosure.

FIG. 4 is a diagram illustrating a frame unit that supports a fixing unit according to the embodiment of the present disclosure.

FIG. 5 is a diagram illustrating the fixing unit and a right guide according to the embodiment of the present disclosure.

FIG. 6 is a diagram illustrating the vicinity of a movement restricting portion in FIG. 5.

FIG. 7 is a diagram illustrating the movement restricting portion according to the embodiment of the present disclosure.

FIG. 8 is a diagram illustrating the movement restricting portion according to another embodiment of the present disclosure.

FIG. 9A is a diagram illustrating a state in which an abutment portion in FIG. 7 does not conform to the shape of a receiving portion in FIG. 8, and FIG. 9B is a diagram illustrating a state in which an abutment portion in FIG. 8 does not conform to the shape of a receiving portion in FIG. 7.

### DETAILED DESCRIPTION

Embodiments of the present disclosure will be described below with reference to the accompanying drawings. However, the present disclosure is not limited to the following embodiments. Note that elements that are the same or equivalent are marked 10 using the same reference signs in the drawings and explanation thereof is not repeated.

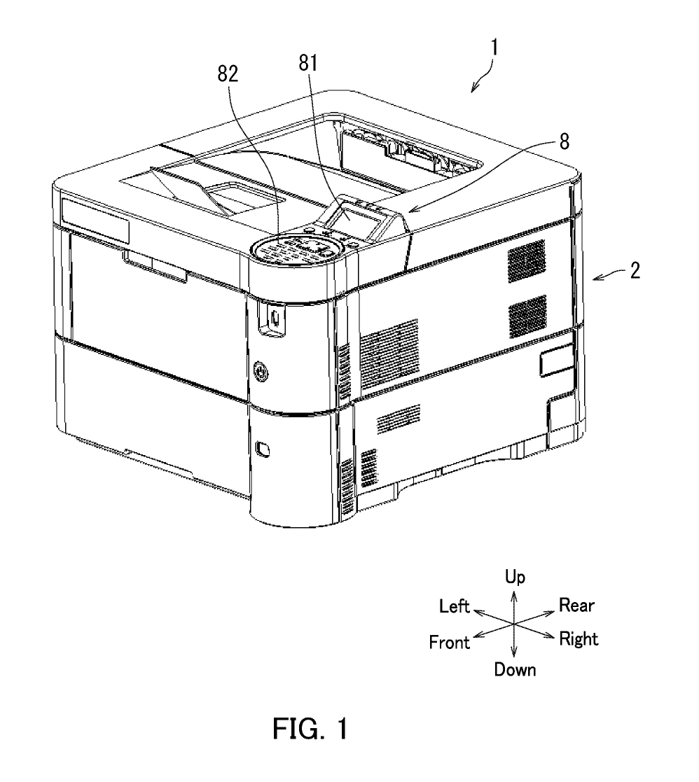

FIG. 1 is a perspective view illustrating an image forming apparatus 1 according to the present embodiment. As illustrated in FIG. 1, the image forming apparatus 1 in the present embodiment is a printer. Alternatively, the image forming apparatus 1 may be a multifunction peripheral. The multifunction peripheral has for example at least two functions among a copy function, a printing function, and a fax function.

The image forming apparatus 1 includes a casing 2 and an operation panel 8. The casing 2 has a rectangular box shape. The casing 2 has an upper end part on which the operation panel 8 is disposed.

The operation panel 8 includes a display section 81 and an input section 82. The display section 81 includes a display. The display includes for example a liquid crystal display (LCD) or an electroluminescent display (ELD). The input section 82 includes a hard key set. The display section 81 may have a function of a touch panel. In a configuration in which the display section 81 has a function of a touch panel, the input section 82 may be united with the display section 81.

Here, a direction in which the display section 81 faces in FIG. 1 is determined to be a front for defining a front-back direction. Also, a left hand side as seen from the front of the image forming apparatus 1 is determined to be the left for defining a left-right direction. A direction perpendicular to the front-back direction and the left-right direction is defined to be an up-down direction.

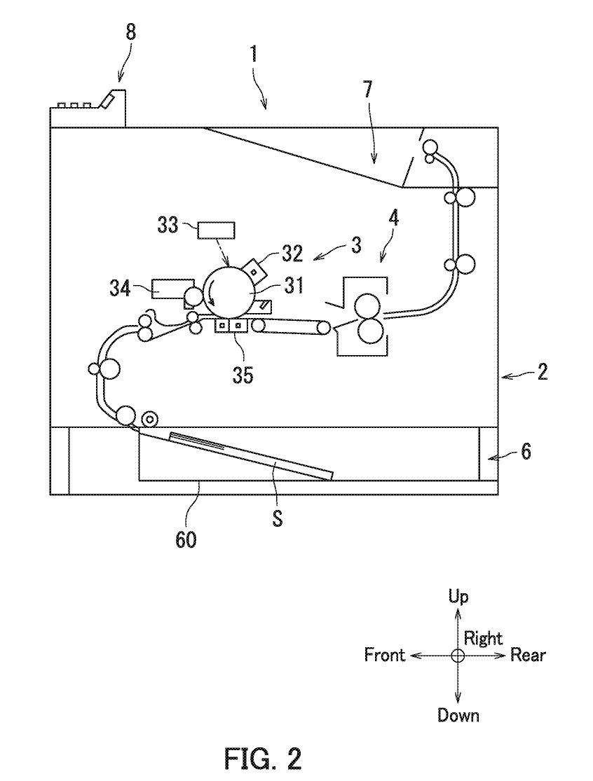

The following describes a configuration of the image forming apparatus 1 with reference to FIG. 2. FIG. 2 is a diagram illustrating the configuration of the image forming apparatus 1. As illustrated in FIG. 2, the image forming apparatus 1 further includes an image forming section 3, a fixing section 4, a sheet feed section 6, and an ejection section 7. The casing 2 accommodates therein the image forming section 3, the fixing section 4, and the sheet feed section 6.

The sheet feed section 6 includes a sheet feed cassette 60. The sheet feed cassette 60 is disposed in a lower part of the casing 2. The sheet feed cassette 60 is attachable to and detachable from the lower part of the casing 2. A plurality of sheets S can be stacked in the sheet feed cassette 60. The sheet feed cassette 60 feeds the sheets S one at a time toward the image forming section 3. The sheet S is an example of a recording medium in the present disclosure. The sheet S is for example plain paper, copy paper, recycled paper, thin paper, thick paper, glossy paper, or an overhead projector (OHP) sheet. The sheet S is conveyed from the sheet feed section 6 to the ejection section 7 through a specific conveyance path.

The image forming section 3 forms a toner image on the sheet S. The image forming section 3 includes an image bearing member 31, a charger 32, a light exposure section 33, a development section 34, and a transfer section 35. The charger 32 charges an outer circumferential surface of the image bearing member 31 to a specific potential. The light exposure section 33 irradiates the charged outer circumferential surface of the image bearing member 31 with laser light. As a result of irradiation, an electrostatic latent image based on image data is formed on the outer circumferential surface of the image bearing member 31. The development section 34 supplies toner to the outer circumferential surface of the image bearing member 31. Through toner supply by the development section 34, the electrostatic latent image is developed into a toner image. The image bearing member 31 forms a transfer nip in cooperation with the transfer section 35. When the sheet S passes through the transfer nip, the toner image is transferred from the image bearing member 31 to the sheet S.

The fixing section 4 is located downstream of the image forming section 3 in the conveyance path of the sheet S. The fixing section 4 fixes to the sheet S the toner image having been transferred to the sheet S. The ejection section 7 is located downstream of the fixing section 4 in the conveyance path of the sheet S. The sheet S to which the toner image has been fixed is ejected onto the ejection section 7.

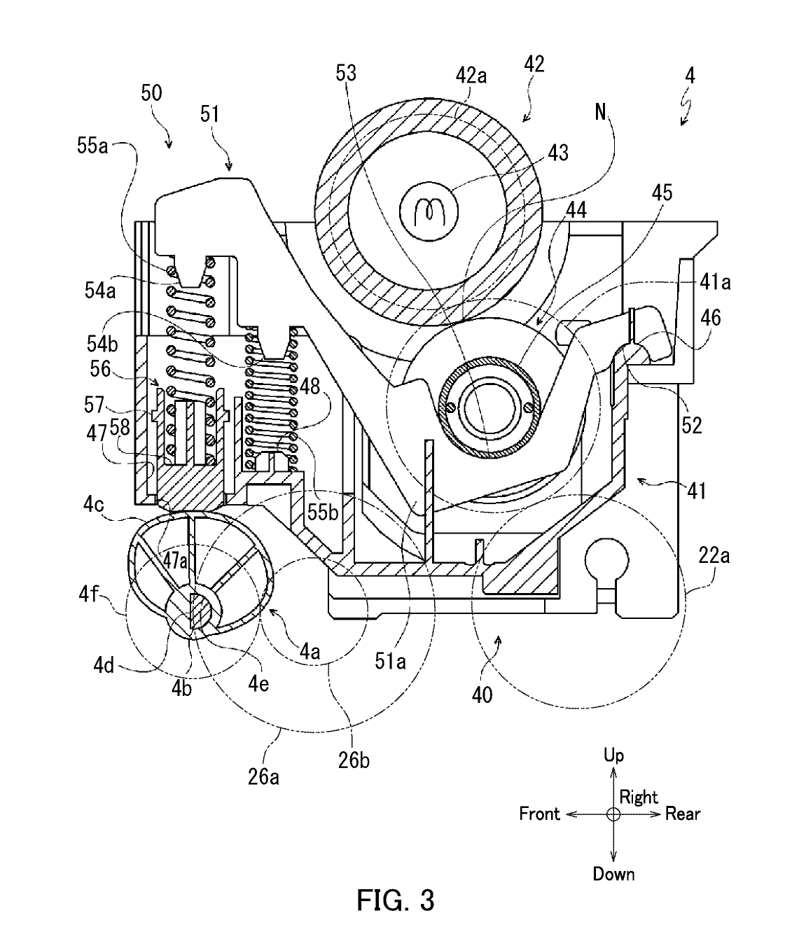

The following describes a configuration of the fixing section 4 with reference to FIG. 3. FIG. 3 is a diagram illustrating the configuration of the fixing section 4. As illustrated in FIG. 3, the fixing section 4 includes a fixing unit 40 and a nip pressure changing section 4a.

The nip pressure changing section 4a includes a shaft 4b and cams 4c. The shaft 4b extends in the left-right direction. The shaft 4b is supported to the fixing unit 40 in a rotatable manner. The cams 4c are disposed on the respective opposite ends of the shaft 4b. Specifically, the cams 4c each have a fitting hole 4d. Fitting portions 4e formed at the respective opposite ends of the shaft 4b are fitted into the respective fitting holes 4d. In the above configuration, the cams 4c rotate together with the shaft 4b. A connection gear 4f is secured to one of the opposite ends of the shaft 4b. The shaft 4b is connected through the connection gear 4f to a power supply provided in the casing 2. The shaft 4b is rotationally driven by power transmitted from the power supply.

The fixing unit 40 is attachable to and detachable from the casing 2 described with reference to FIG. 2. The fixing unit 40 includes a fixing unit frame 41, a heating roller 42, a pressure roller 44, and a fixing nip forming section 50.

The heating roller 42 has a cylindrical shape extending in the left-right direction. The heating roller 42 includes for example a core, an elastic layer surrounding the core, and a mold release layer covering the elastic layer. The core is made from for example metal such as aluminum or iron. The elastic layer is for example made from silicone rubber. The mold release layer is for example made from fluororesin such as perfluoroalkoxy fluororesin (PFA).

The heating roller 42 is a drive roller that rotates by power transmitted from a specific power supply. A fixing gear 42a is secured to the right end of the heating roller 42. A fixing driving power input gear 41a that meshes with the fixing gear 42a is disposed on the right side surface of the fixing unit frame 41. The fixing driving power input gear 41a meshes with a drive gear 22a connected to the specific power supply.

The specific power supply is for example a motor. A heat source 43 is accommodated in the interior of the heating roller 42. The heat source 43 is a heater such as a halogen heater or a ceramic heater. When energized, the heat source 43 radiates heat to the surroundings. Heat radiation by the heat source 43 heats the outer surface of the heating roller 42.

The pressure roller 44 has a cylindrical shape extending in the left-right direction. The pressure roller 44 includes for example a core, an elastic layer surrounding the core, and a mold release layer covering the elastic layer, similarly to the heating roller 42. The pressure roller 44 is supported by bearings 45 disposed at the opposite right and left ends of the pressure roller 44. The pressure roller 44 is a driven roller that follows rotation of the heating roller 42.

The fixing unit frame 41 has a box shape. The fixing unit frame 41 accommodates therein the heating roller 42 and the pressure roller 44. The fixing unit frame 41 includes engaging targets 46, holder accommodating portions 47, and frame-side spring receivers 48.

The respective engaging targets 46 are located at the right rear end and the left rear end of the fixing unit frame 41. The engaging targets 46 each are a semicircular shape having an apex at the upper end thereof. The respective holder accommodating portions 47 are formed at the left front end and the right front end of the fixing unit frame 41. The respective holder accommodating portions 47 have insertion holes 47a. The insertion holes 47a each pass through the bottom (lower end) of a corresponding one of the holder accommodating portions 47. The frame-side spring receivers 48 are located in front of the respective holder-side spring receivers 58. The frame-side spring receivers 48 each include for example a columnar protruding portion.

The fixing nip forming section 50 includes pressure members 51, first springs 55a, second springs 55b, and spring holders 56. The respective pressure members 51 are disposed on the right and left ends of the fixing unit frame 41. The spring holders 56 are disposed in front of and below the respective pressure members 51.

The spring holders 56 are accommodated in the interior of the respective holder accommodating portions 47 of the fixing unit frame 41 so as to be movable in the up-down direction. The spring holders 56 are inserted into the respective insertion holes 47a of the holder accommodating portions 47. The spring holders 56 each have a bottomed hollow cylindrical shape. The spring holders 56 each have a lower end that is in contact with a corresponding one of the cams 4c of the nip pressure changing section 4a. The spring holders 56 each include a protruding stopper 57 and a holder-side spring receiver 58.

The protruding stoppers 57 protrude outward from the circumferential surfaces of upper parts of the respective hollow cylindrical spring holders 56. The protruding stoppers 57 prevent the respective spring holders 56 from falling down from the corresponding holder accommodating portions 47. The holder-side spring receivers 58 are formed in the interior of the respective hollow cylindrical spring holders 56. The holder-side spring receivers 58 each include for example a columnar protruding portion.

Each of the pressure members 51 is for example a plate member. The pressure member 51 has for example a substantially L-shape. The pressure member 51 has a bent portion 51a at a central part thereof in the front-back direction. The pressure member 51 further has an engaging portion 52, a holding portion 53, a first spring receiving portion 54a, and a second spring receiving portion 54b.

The engaging portion 52 is located at the rear end of the pressure member 51. The engaging portion 52 engages with a corresponding one of the engaging targets 46 of the fixing unit frame 41. As a result of engagement, the pressure members 51 are supported by the fixing unit frame 41. The engaging portion 52 has a arcuate shape. In the above configuration, the pressure member 51 is supported in a manner swingable about a corresponding one of the respective engaging portions 52 as a center.

The holding portion 53 is located between the bent portion 51a and the engaging portion 52. The holding portion 53 has a arcuate shape. The holding portion 53 holds a corresponding one of the bearings 45 for the pressure roller 44. Through the above, the pressure roller 44 is supported to the fixing unit frame 41.

The first spring receiving portion 54a is located at the front end of the pressure member 51. The first springs 55a that are coiled are disposed between the respective first spring receiving portions 54a and the respective holder-side spring receivers 58.

The second spring receiving portion 54b is located between the bent portion 51a and the first spring receiving portion 54a. The second springs 55b that are coiled are disposed between the respective second spring receiving portions 54b and the respective frame-side spring receivers 48. The second springs 55b urge the respective pressure members 51 upward. In the above configuration, the pressure members 51 push the pressure roller 44 toward the heating roller 42. As a result, the pressure roller 44 is pressed into contact with the heating roller 42 to form a fixing nip N between the heating roller 42 and the pressure roller 44. Heat and pressure are applied to the sheet S when the sheet S passes through the fixing nip N. As a result, a toner image is fixed to the sheet S.

The cams 4c are rotated to push the respective spring holders 56 upward in the image forming apparatus 1 according to the present embodiment. When the spring holders 56 are pushed upward, the pressure members 51 are urged upward further strongly by the respective first springs 55a. As a result, the pressure members 51 push the pressure roller 44 toward the heating roller 42 further strongly. Thus, the pressure roller 44 is pressed into contact with the heating roller 42 further strongly to increase the nip pressure of the fixing nip N. In the image forming apparatus 1 according to the present embodiment, the nip pressure is released when the cams 4c are further rotated. Specifically, when the cams 4c are further rotated, urging force of the first springs 55a pushes the spring holders 56 downward. As a result, the front ends of the pressure members 51 each swing about a corresponding one of the engaging portions 52 as a center to move the pressure roller 44 in a direction away from the heating roller 42.

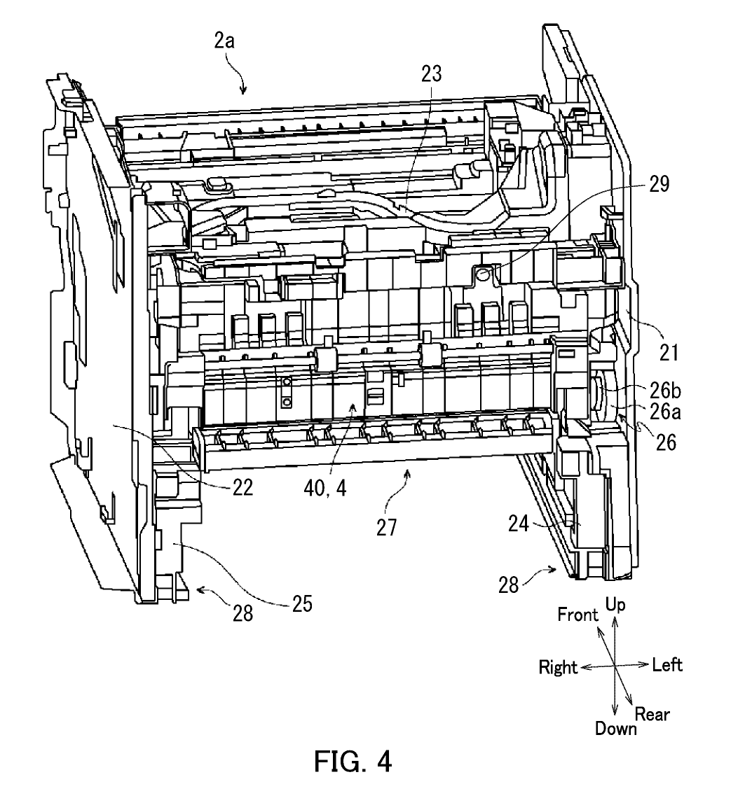

The following describes a configuration of a frame unit 2a supporting the fixing unit 40 with reference to FIG. 4. FIG. 4 is a diagram illustrating the frame unit 2a supporting the fixing unit 40. As illustrated in FIG. 4, the frame unit 2a includes a left frame 21, a right frame 22, a main frame 23, a left guide 24, a right guide 25, a unit fitting compartment 27, and a securing member 29.

Once the fixing unit 40 is fitted into the unit fitting compartment 27, an upper end of the fixing unit 40 is secured to the frame unit 2a.

The left frame 21 and the right frame 22 each have a plate shape. The left frame 21 faces the right frame 22. The main frame 23 extends across between the left frame 21 and the right frame 22. The main frame 23 supports the image forming section 3 described with reference to FIG. 2 and the fixing unit 40 described with reference to FIG. 3. A conveyance unit and the like forming the conveyance path of the sheet S are mounted on the main frame 23.

The left guide 24 and a connecting portion 26 are mounted on the left frame 21. The left guide 24 is located at the inner lower end of the left frame 21. The left guide 24 has a guide groove 28. The guide groove 28 of the left guide 24 extends in the inner lower end of the left guide 24. The guide groove 28 of the left guide 24 extends in the front-back direction. The connecting portion 26 is located at the upper end of the left guide 24. The connecting portion 26 is for example a gear including a large-diameter portion 26a connected to a power supply and a small-diameter portion 26b connected to the connection gear 4f secured to the shaft 4b described with reference to FIG. 3. Note that when power of the power supply is transmitted to the connection gear 4f from the small-diameter portion 26b, force pushing the fixing unit 40 frontward acts on the connection gear 4f.

The right guide 25 is mounted on the inner lower end of the right frame 22. A part of the shaft 4b that is supported is located at the upper end of the right guide 25. The right guide 25 has a guide groove 28. The guide groove 28 of the right guide 25 extends in the inner lower end of the right guide 25. The guide groove 28 of the right guide 25 extends in the front-back direction. The guide grooves 28 of the right and left guides 25 and 24 guide the sheet feed cassette 60 described with reference to FIG. 2 in the front-back direction in attachment and detachment of the sheet feed cassette 60 to and from the casing 2. The drive gear 22a described with reference to FIG. 3 is located on the right frame 22. When the power of the specific power supply is transmitted from the drive gear 22a to the fixing gear 42a via the fixing driving power input gear 41a, force pushing the fixing unit 40 frontward acts on the fixing driving power input gear 41a.

The unit fitting compartment 27 is defined below the main frame 23 between the right and left frames 22 and 21. The fixing unit 40 is fitted into the unit fitting compartment 27 from the rear of the casing 2. The fixing unit 40 once fitted into the unit fitting compartment 27 is secured to the main frame 23 by means of the securing member 29. The securing member 29 is for example a screw.

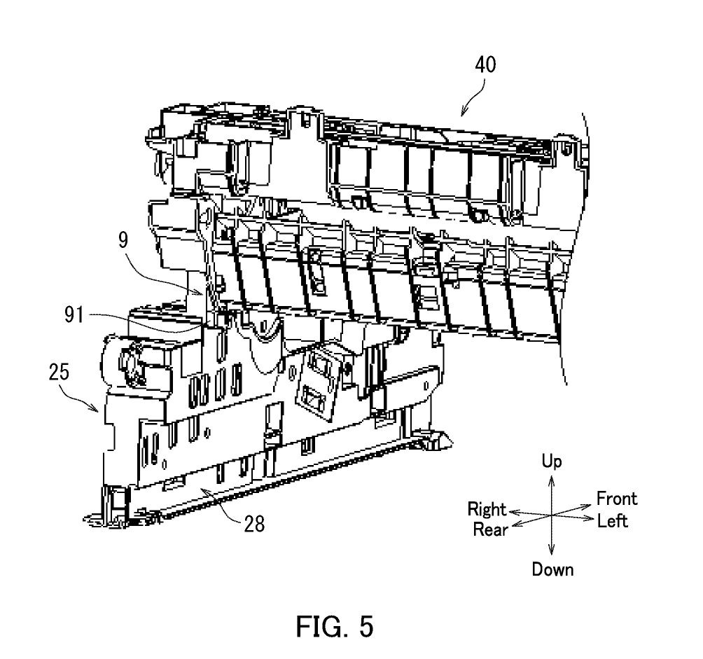

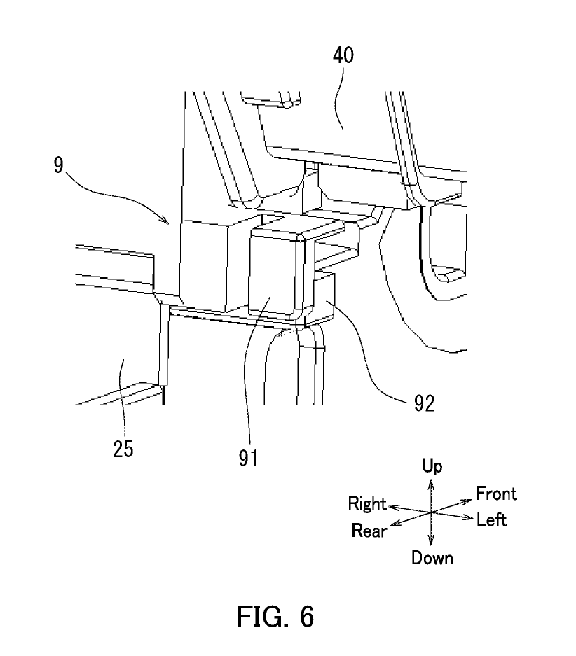

Respective configurations of the fixing unit 40 and the right guide 25 will be further described next with reference to FIGS. 5 and 6. FIG. 5 is a diagram illustrating the fixing unit 40 and the right guide 25. FIG. 6 is a diagram illustrating the vicinity of a movement restricting portion 9 in FIG. 5.

As illustrated in FIG. 5, a combination of the fixing unit 40 and the right guide 25 forms the movement restricting portion 9. The movement restricting portion 9 is located at the rear end of the fixing unit 40 in the present embodiment. As illustrated in FIG. 6, the movement restricting portion 9 includes an abutment portion 91 and a receiving portion 92. The fixing unit frame 41 includes the abutment portion 91. The abutment portion 91 protrudes rearward from the rear surface of the fixing unit frame 41. The abutment portion 91 is located at the bottom of the rear end of the fixing unit frame 41 in the present embodiment.

The right guide 25 includes the receiving portion 92. The receiving portion 92 protrudes leftward from the left side surface of the right guide 25. The receiving portion 92 is located at the rear end of the upper surface of the right guide 25. The receiving portion 92 receives the abutment portion 91 once the fixing unit 40 is fitted into the unit fitting compartment 27.

The fixing unit 40 is secured to the main frame 23 in a state in which the abutment portion 91 of the fixing unit 40 having been brought into contact with the receiving portion 92 of the right guide 25 from the rear of the casing 2 is received by the receiving portion 92 from the rear of the casing 2 in the image forming apparatus 1 according to the present embodiment. In the above configuration, vibration of the fixing unit 40 generated in driving of the heating roller 42 and the pressure roller 44 described with reference to FIG. 3 can be reduced and eventually noise generated from the fixing unit 40 can be reduced. Furthermore, a situation can be prevented in which the fixing unit 40 is displaced relative to the unit fitting compartment 27 due to stress received from the nip pressure changing section 4a in change of the nip pressure of the fixing nip N. As a result, an increase in noise generated from the fixing unit 40, which is due to displacement of the fixing unit 40 relative to the unit fitting compartment 27, can be suppressed. Note that in a configuration in which the image forming apparatus 1 does not include the movement restricting portion 9, the fixing unit 40 may displace typically frontward relative the unit fitting compartment 27 by rotation of the cams 4c described with reference to FIG. 3.

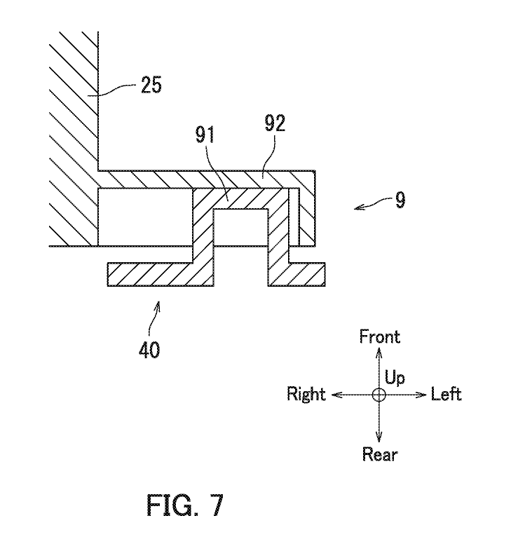

The following further describes a configuration of the movement restricting portion 9 with reference to FIG. 7. FIG. 7 is a diagram illustrating the movement restricting portion 9. As illustrated in FIG. 7, the receiving portion 92 is a recessed portion having a specific width in the left-right direction. On the other hand, the abutment portion 91 has a specific shape in accordance with the specification of the image forming apparatus 1 capable of incorporating the fixing unit 40. The abutment portion 91 in the present embodiment is a protruding portion capable of being inserted into the receiving portion 92.

When a fixing unit incapable of being incorporated in (incompatible with) the image forming apparatus 1 is tried to be fitted into the unit fitting compartment 27, for example, an abutment portion 91 of the fixing unit cannot be inserted into the receiving portion 92 and is positioned at an improper location. This prevents the fixing unit incompatible with the image forming apparatus 1 from being fitted into the unit fitting compartment 27. Thus, a situation in which any fixing unit incompatible with the image forming apparatus 1 is fitted into the unit fitting compartment 27 in error can be prevented.

The image forming apparatus 1 according to an embodiment of the present disclosure has been described so far with reference to FIGS. 1 to 7. However, the present disclosure is not limited to the above-described embodiment and can be practiced in various ways within a scope not departing from the gist of the present disclosure.

For example, the abutment portion 91 is provided at the rear end of the bottom surface of the fixing unit frame 41 while the receiving portion 92 is provided at the rear end of the upper surface of the right guide 25 in the embodiment of the present disclosure, which however should not be taken to limit the present disclosure. It is only required that the abutment portion 91 is provided at the fixing unit frame 41 while the receiving portion 92 is provided at a position of the frame unit 2a that can receive the abutment portion 91 when the fixing unit 40 is fitted into the unit fitting compartment 27. Therefore, the receiving portion 92 may be provided at a position of the frame unit 2a other than the right guide 25.

The movement restricting portion 9 in the embodiment of the present disclosure is provided only at the right part of the image forming apparatus 1, which however should not be taken to limit the present disclosure. Alternatively, the movement restricting portion 9 can be provided at each of the right and left parts of the image forming apparatus 1.

The abutment portion 91 is a protruding portion while the receiving portion 92 is a recessed portion in the embodiment of the present disclosure, which however should not be taken to limit the present embodiment. It is only required that the abutment portion 91 conforms to the shape of the receiving portion 92 in a configuration in which the fixing unit 40 is compatible with the image forming apparatus 1. Specifically, it is only required that the abutment portion 91 and the receiving portion 92 have shapes that allow the fixing unit 40 to be positioned at a location where the fixing unit 40 can be secured to the main frame 23 by means of the securing member 29. In other words, the abutment portion 91 and the receiving portion 92 are only required to have shapes that allow the fixing unit 40 to be fitted into the unit fitting compartment 27.

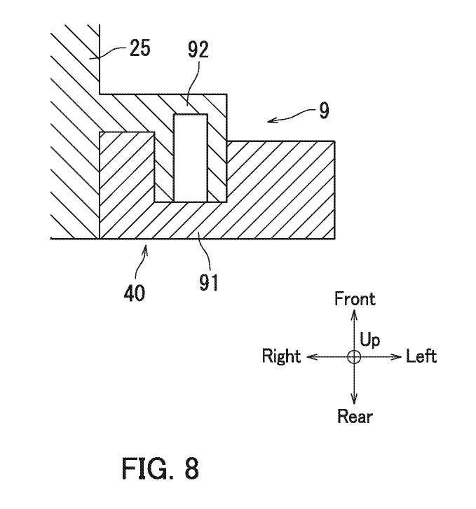

FIG. 8 is a diagram illustrating a movement restricting portion 9 according to an alternative embodiment of the present disclosure. As illustrated in FIG. 8, an abutment portion 91 is a recessed portion while a receiving portion 92 is a protruding portion in the movement restricting portion 9 according to the alternative embodiment. Operation and advantages similar to those achieved by providing the movement restricting portion 9 described with reference to FIG. 7 can also be achieved by providing the movement restricting portion 9 illustrated in FIG. 8.

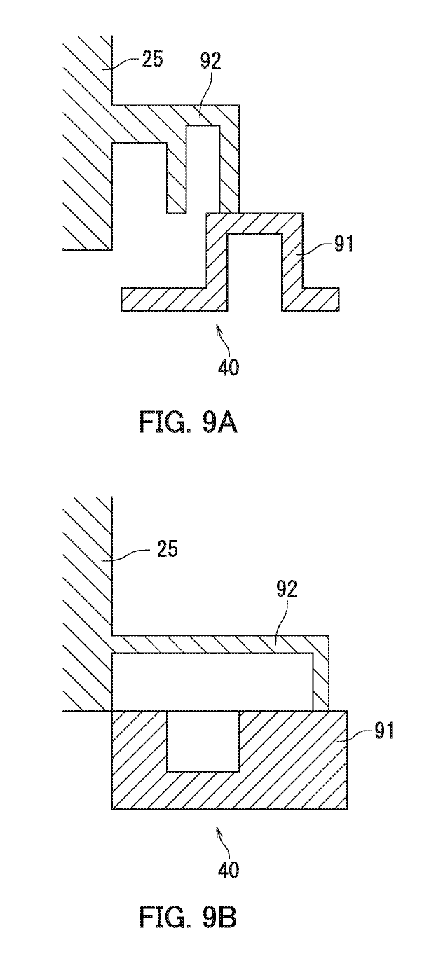

The following describes a fixing unit incompatible with the image forming apparatus 1 with reference to FIGS. 9A and 9B. FIGS. 9A and 9B each illustrate a state in which the abutment portion 91 does not conform to the shape of the receiving portion 92. Here, the specification of the image forming apparatus 1 including the receiving portion 92 illustrated in FIG. 7 is different from that of an image forming apparatus 1 including the receiving portion 92 illustrated in FIG. 8.

As illustrated in FIG. 9A, even when the fixing unit 40 including the abutment portion 91 described with reference to FIG. 7 is tried to be fitted into a unit fitting compartment 27 of a frame unit 2a (right guide 25) including the receiving portion 92 described with reference to FIG. 8, the abutment portion 91 does not conform to the shape of the receiving portion 92. Specifically, the tip end of the protruding abutment portion 91 collides with the tip end of the protruding receiving portion 92 with a result that the fixing unit 40 cannot be fitted into the unit fitting compartment 27. As such, a situation in which a fixing unit incompatible with the image forming apparatus 1 is fitted into the unit fitting compartment 27 in error can be prevented.

Also, as illustrated in FIG. 9B, even when a fixing unit 40 including the abutment portion 91 described with reference to FIG. 8 is tried to be fitted into the unit fitting compartment 27 of the frame unit 2a (right guide 25) including the receiving portion 92 described with reference to FIG. 7, the abutment portion 91 does not conform to the shape of the receiving portion 92. Specifically, the abutment portion 91 that is a recessed portion cannot be inserted into the receiving portion 92 that is a recessed portion and the abutment portion 91 collides with the receiving portion 92 with a result that the fixing unit 40 cannot be fitted into the unit fitting compartment 27.

The drawings are schematic illustrations that emphasize elements of configuration in order to facilitate understanding thereof. Therefore, in order that elements of configuration can be easily illustrated, dimensions such as thickness and length of each of the elements of configuration in the drawings may differ from the actual dimensions thereof. The shape and so on of each element of configuration in the above embodiments are merely examples that do not impose any particular limitations and can be altered in various ways to the extent that there is no substantial deviation from the advantages of the present disclosure.

What is claimed is:

1. An image forming apparatus comprising:
an image forming section configured to form a toner image on a recording medium;
a fixing section configured to fix the toner image to the recording medium; and
a frame unit that supports the image forming section and the fixing section, wherein
the fixing section includes a fixing unit and a nip pressure changing section, the fixing unit forming a fixing nip that applies heat and pressure to the recording medium, the nip pressure changing section changing nip pressure of the fixing nip,
the fixing unit includes an abutment portion, and
the frame unit includes:
a unit fitting compartment into which the fixing unit is to be fitted; and
a receiving portion that receives the abutment portion once the fixing unit is fitted into the unit fitting compartment.

2. The image forming apparatus according to claim 1, wherein
the abutment portion of the fixing unit is a recessed portion, and
the receiving portion of the frame unit is a protruding portion.

3. The image forming apparatus according to claim 1, wherein
the abutment portion of the fixing unit is a protruding portion, and
the receiving portion of the frame unit is a recessed portion.

4. The image forming apparatus according to claim 1, wherein
the abutment portion of the fixing unit conforms to a shape of the receiving portion of the frame unit.

5. The image forming apparatus according to claim 1, wherein
when the fixing unit is fitted into the unit fitting compartment of the frame unit, the abutment portion of the fixing unit fits the receiving portion of the frame unit.

6. The image forming apparatus according to claim 1, wherein
the fixing unit further includes a roller pair that forms the fixing nip and a driving power input gear that rotationally drives the roller pair,
the nip pressure changing section includes a rotary shaft rotatably supported to the frame unit, a cam member secured to the rotary shaft, and a connection gear that rotationally drives the rotary shaft,
the frame unit includes a drive gear and a connecting portion, the drive gear meshing with the driving power input gear to transmit power to the driving power input gear, the connecting portion meshing with the connection gear to transmit the power to the connection gear, and
in power transmission from the drive gear to the driving power input gear and from the connecting portion to the connection gear, force urging the abutment portion of the fixing unit toward the receiving portion of the frame unit acts on the fixing unit.

7. The image forming apparatus according to claim 6, wherein
the driving power input gear of the fixing unit is disposed on one of opposite ends of the fixing unit in a longitudinal direction of the fixing unit, and
the connection gear of the nip pressure changing section is disposed on the other of the opposite ends of the fixing unit.

8. The image forming apparatus according to claim 1, wherein
once the fixing unit is fitted into the unit fitting compartment of the frame unit, an upper end of the fixing unit is secured to the frame unit, and
the abutment portion of the fixing unit is located at a lower end of the fixing unit.
